(19) United States
(12) Patent Application Publication
(10) Pub. No.: US 2025/0121561 A1
(43) Pub. Date: Apr. 17, 2025

(54) Powder Bed Preparation for Additive Manufacturing

(71) Applicant: Seurat Technologies, Inc., Wilmington, MA (US)

(72) Inventors: Yiyu Shen, Tewksbury, MA (US); James A. DeMuth, Woburn, MA (US); Andrew J. Bayramian, Marblehead, MA (US); Ning Duanmu, Nashua, NH (US); Drew W. Kissinger, Carlisle, MA (US); Joseph Gillespie, Boxford, MA (US)

(21) Appl. No.: 18/912,150

(22) Filed: Oct. 10, 2024

Related U.S. Application Data
(60) Provisional application No. 63/589,912, filed on Oct. 12, 2023.

(51) Int. Cl. B29C 64/209; B29C 64/153; B29C 64/214; B29C 64/218; B29C 64/268; B33Y 10/00; B33Y 30/00

(52) U.S. Cl. CPC B29C 64/209; B29C 64/153; B29C 64/214; B29C 64/218; B29C 64/268; B33Y 10/00; B33Y 30/00

(57) ABSTRACT

A print engine of an additive manufacturing system includes a print station with a print bed, powder spreader, and a first and a second powder holding chamber. First and second powder nozzles are respectively connected to the first and a second powder holding chambers. At least one vibratory element is attached to at least one of the print bed, the powder spreader, the first and a second powder holding chambers, and the first and second powder nozzles. In one embodiment, a laser able to direct a two dimensional laser image against the print bed is provided. In another embodiment, size of powder held in the respective first and a second powder holding chambers is different.

### RELATED APPLICATION

The present disclosure is part of a non-provisional patent application claiming the priority benefit of U.S. Patent Application No. 63/589,912, filed on Oct. 12, 2023, which is incorporated by reference in its entirety.

### TECHNICAL FIELD

The present disclosure generally relates to a system and method for powder bed preparation for high throughput additive manufacturing. In one embodiment, high speed manufacturing is supported by use of vibratory elements for handling and distributing various sized powders on a print bed.

### BACKGROUND

Traditional component machining often relies on removal of material by drilling, cutting, or grinding to form a part. In contrast, additive manufacturing, also referred to as 3D printing, typically involves sequential layer by layer addition of material to build a part. Beginning with a 3D computer model, an additive manufacturing system can be used to create complex parts from a wide variety of materials.

One additive manufacturing technique known Powder Bed Fusion Additive Manufacturing (PBF-AM) uses one or more focused energy sources to draw a pattern in a thin layer of powder by melting the powder and bonding it to the layer below to gradually form a 3D printed part. Powders can be plastic, metal, glass, ceramic, crystal, other meltable material, or a combination of meltable and unmeltable materials (i.e. plastic and wood or metal and ceramic). Packing density of powder prior to fusing in can play an important role in the density of the final printed parts. Pores, voids, and cracks (printing defects) can occur with low packing density or unwanted variability in powder spreading or distribution.

### SUMMARY

In some embodiments a print engine of an additive manufacturing system, includes a print station with a print bed, a powder spreader, and a first and a second powder holding chamber. First and second powder nozzles are respectively connected to the first and a second powder holding chambers. At least one vibratory element is attached to at least one of the print bed, the powder spreader, the first and a second powder holding chambers, and the first and second powder nozzles. In one embodiment, a laser able to direct a two dimensional laser image against the print bed is provided. In another embodiment, size of powder held in the respective first and a second powder holding chambers is different.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIGS. 1A(i-iii) illustrates an example of a dual-layer powder spreading system in PBF-AM systems

FIGS. 1B(i-ii) illustrates an example of vibrational agitators on the hopper and nozzle for improved powder flow and control

FIGS. 1C(i-ii) illustrates an example of using a z-axis stage 100C as a method for spreading and compaction.

FIGS. 1D(i-iii) illustrate an example embodiment supporting vibration packing for print compaction on a print bed 100D.

FIGS. 1E(i-iii) illustrates an example of structured rollers for enhanced powder spreading

FIGS. 1F(i-iii) illustrates an example of powder sifting rollers for powder spreading

FIGS. 1G(i-ii) illustrates an embodiment of a system 100G that supports an ultrasonic agitated blade 130G for better powder spreading uniformity.

FIGS. 1H(i-iii) illustrates an example of using a hopper system including a lopped screen or mesh as a spreader and micro-doser

FIG. 1I illustrates an example of vacuum driven layer control to achieve uniform spread layers

FIG. 1J illustrates an example of electrostatic driven layer control to achieve uniform spread layers

FIG. 2A illustrates a cartridge based additive manufacturing system that can be provided with new or recycled powder;

FIG. 2B illustrates a block diagram an of example additive manufacturing system suitable for handling and containing new or recycled powder;

FIG. 2C illustrates a method of additive manufacturing system suitable for handling and containing new or recycled powder;

FIG. 3 illustrates a cartridge based additive manufacturing system able to provide one or two dimensional light beams to a cartridge;

FIG. 4 illustrates a method of operating a cartridge based additive manufacturing system able to provide one or two dimensional light beams to a cartridge; and

FIG. 5 illustrates an additive manufacturing system that includes a phase change light valve and a switchyard.

### DETAILED DESCRIPTION

In the following description, reference is made to the accompanying drawings that form a part thereof, and in which is shown by way of illustrating specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the scope of the present disclosure. The following detailed description is, therefore, not to be taken in a limiting sense.

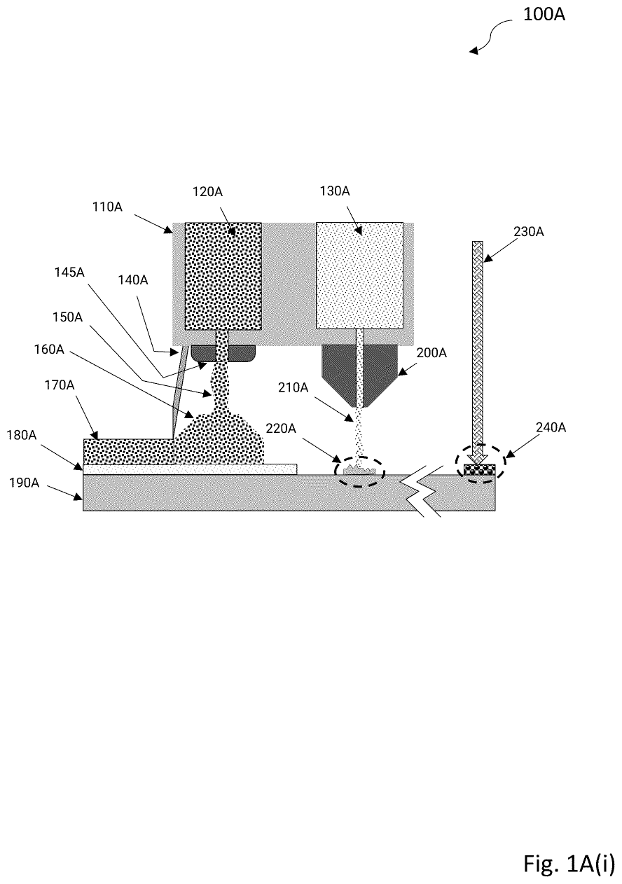

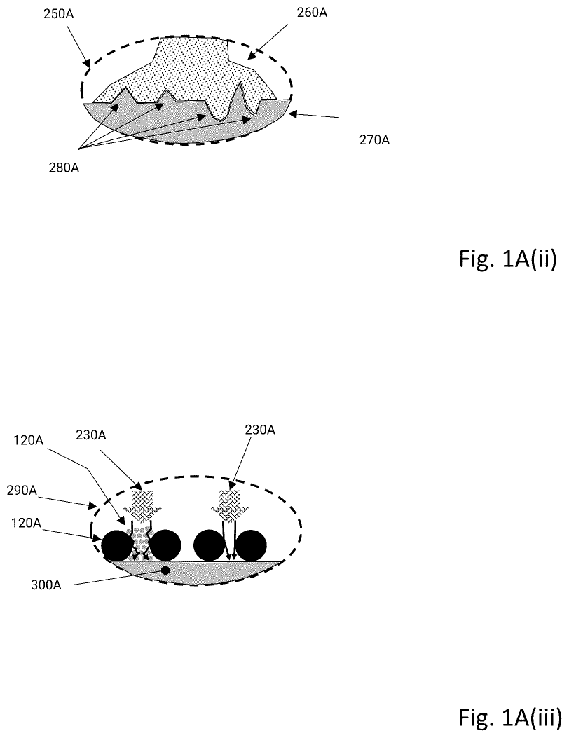

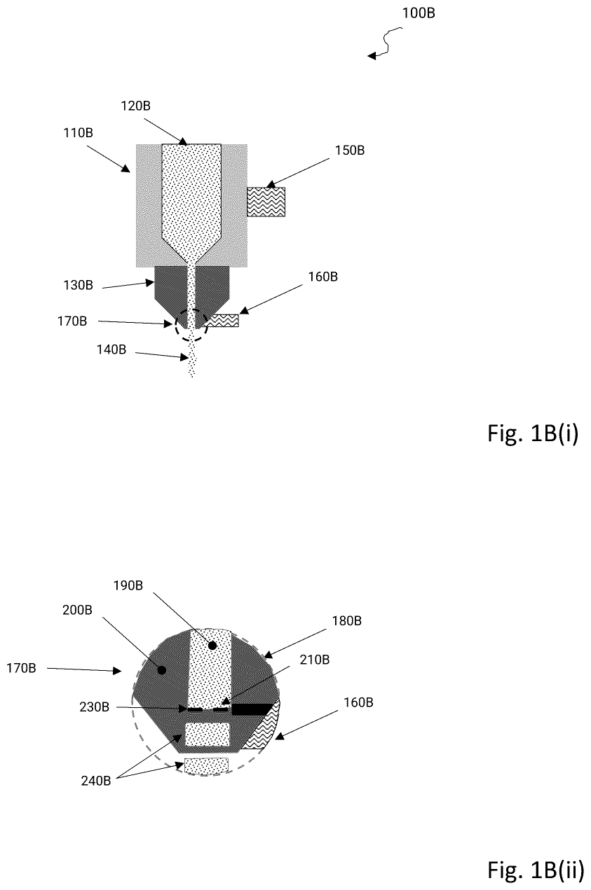

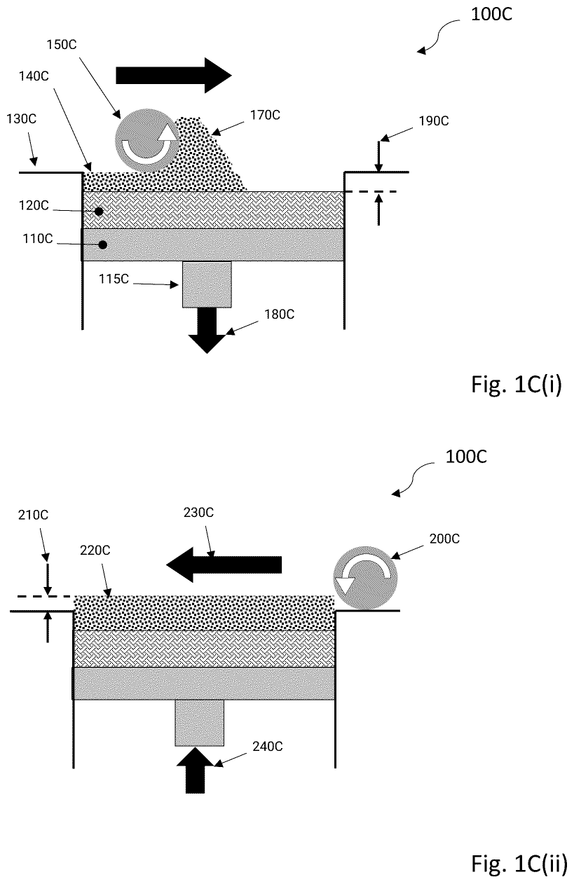

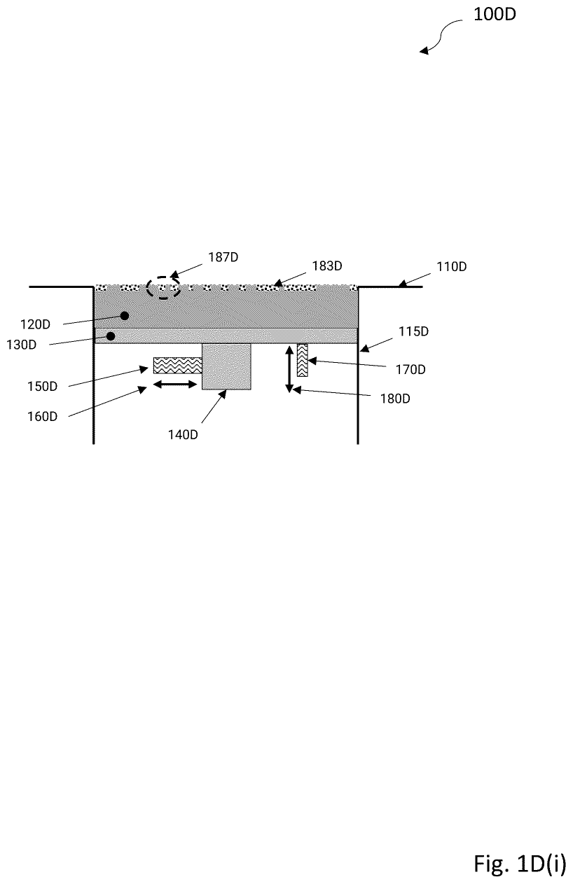

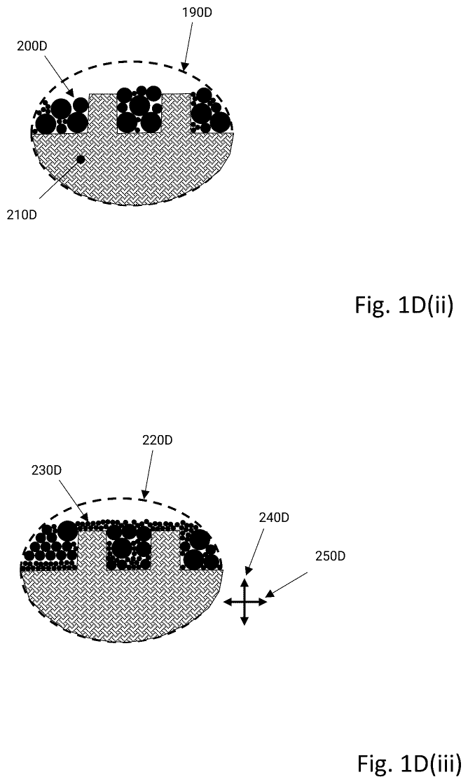

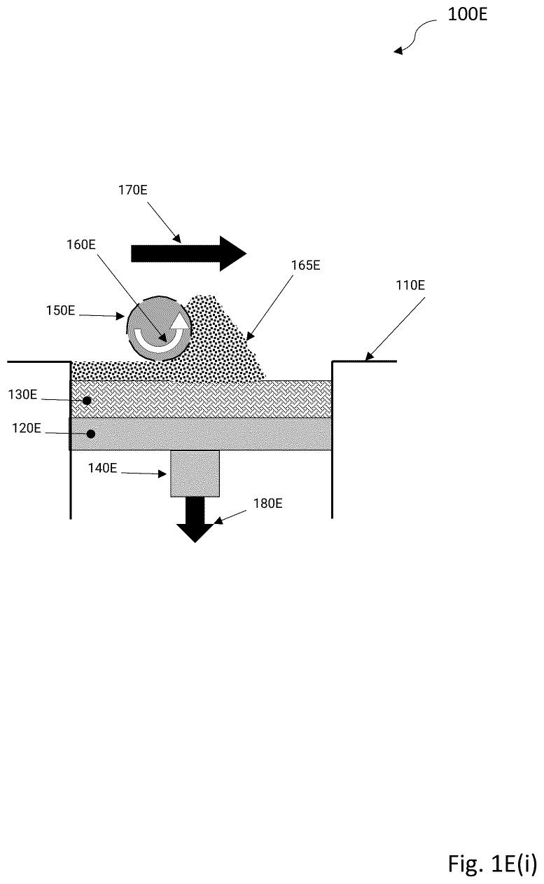

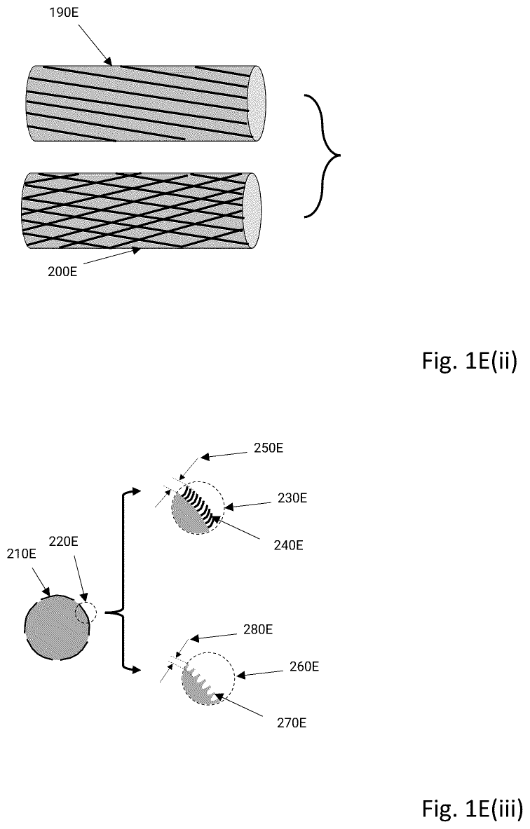

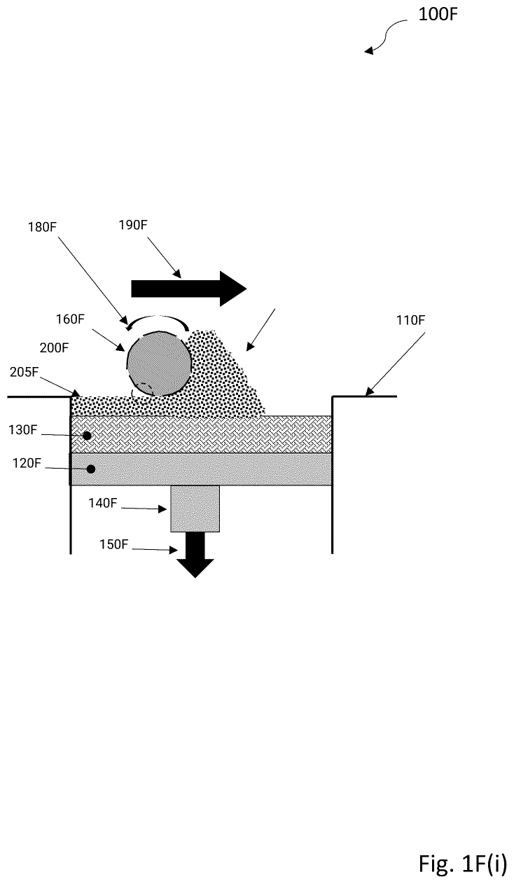

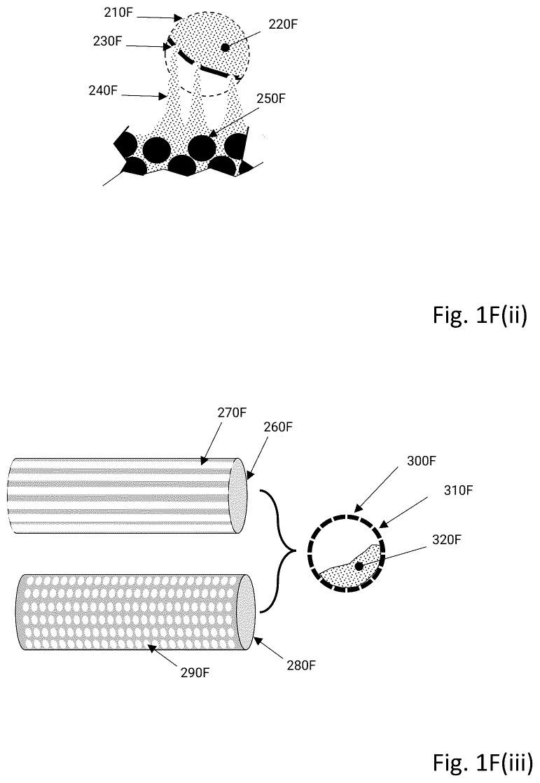

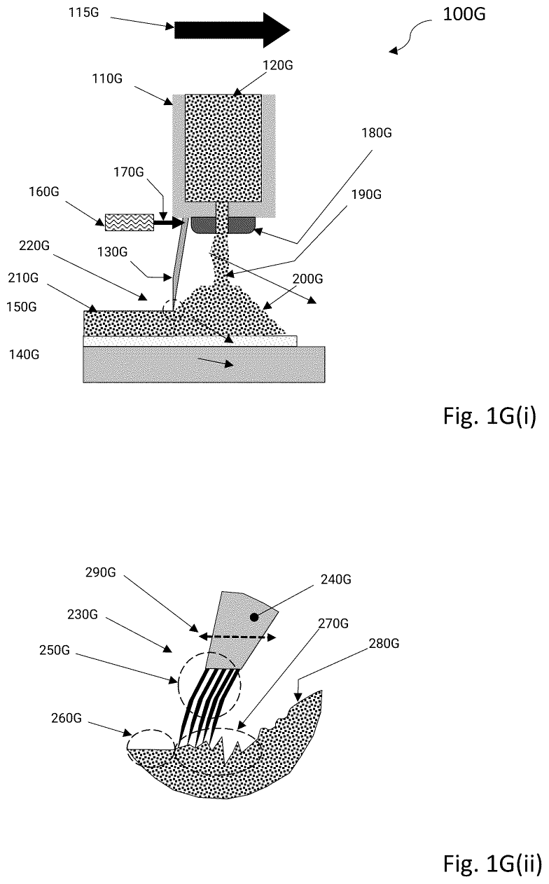

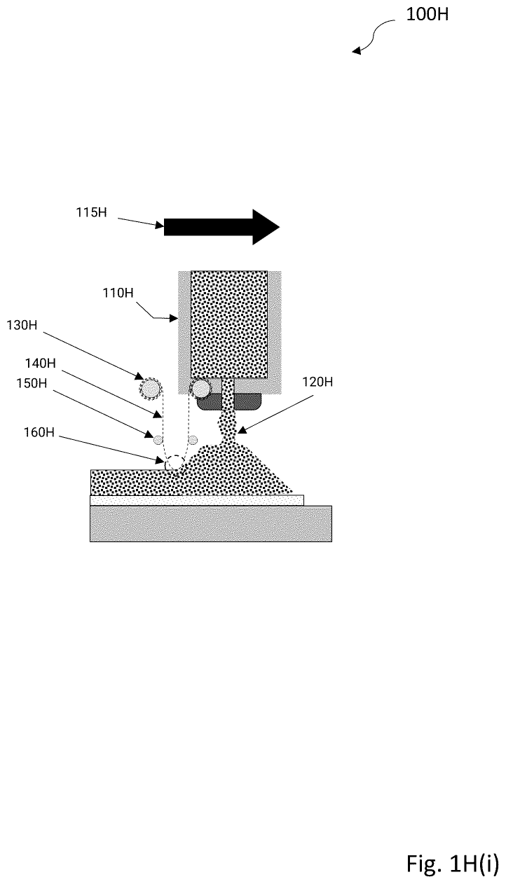

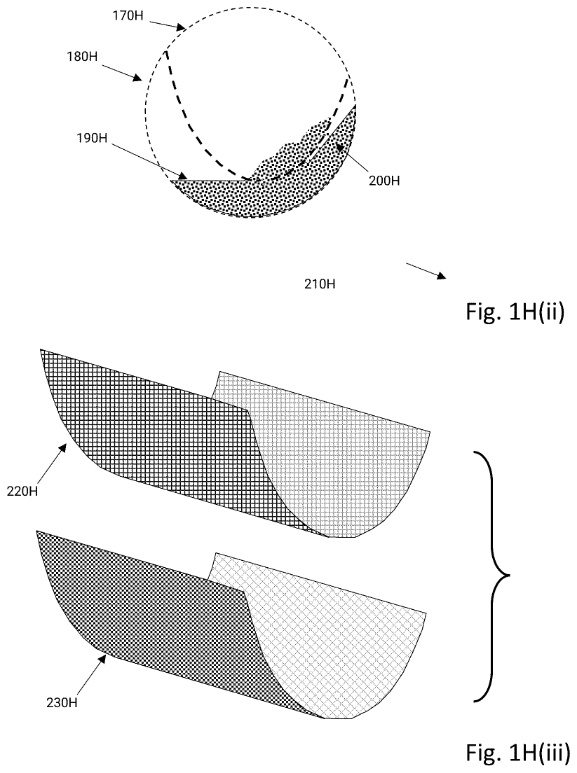

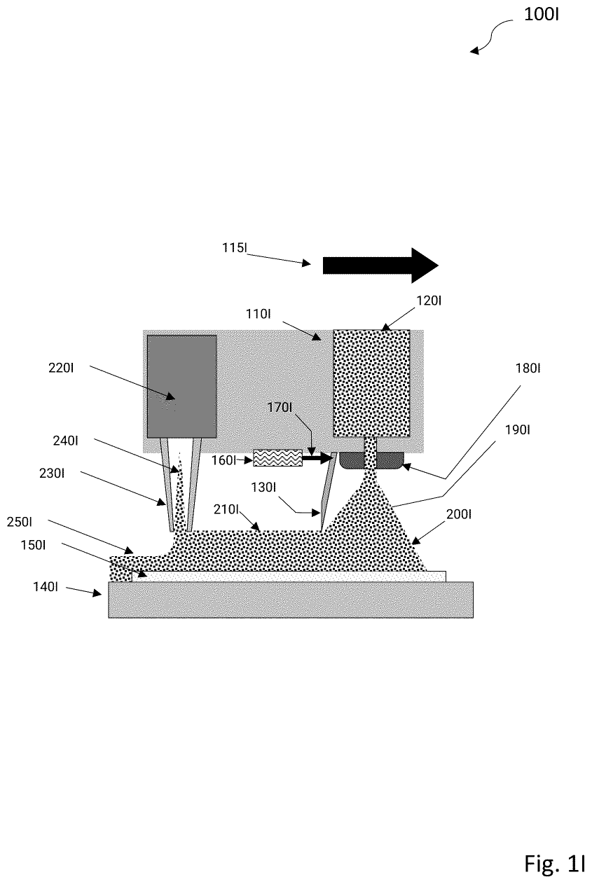

FIG. 1A illustrates an example of a dual powder spreading system for PBF-AM (100A) capable of use in fixed, replaceable, or cartridge based powder handling systems. In this system, a dual hopper, 110A, holds two powder distributions, noted as large diameter powder 120A and small diameter powder 130A. A blade is attached to the dual hopper 110A and is used to spread large diameter powder 120A and (in some examples to a lesser extent) small diameter powder 130A into a uniform powder surface 170A. The large diameter powder 120A is distributed (dosed) onto either previously processed (printed) surface 180A or if the print process is starting fresh, onto a bare print plate 190A through the dosing head 145A. The dosing head 145A controls the flow of 120A out of 110A and into a dose 150A to form a slight pile 160A before being spread by spreader blade 140A. The small diameter powder 130A is dosed through its own dosing head 200A prior to large diameter powder 120A being dosed by the dosing head 145A due to the motion of the hopper 230A. The small diameter powder is released in a dose 210A and falls onto a previously printed feature 220A or atop the previously processed surface 180A or bare print plate 190A. This is depicted as previously printed feature 220A is depicted in detail 250A. Release of small diameter powder 130A through dosing head 200A and into dose 210A can also occur at any time before a high fluence laser (HFL) 230A interacts with previously dosed large diameter powder 120A and/or small diameter powder 130A. The HFL 230A interacts with previously dosed examples of large diameter powder 120A in combination with, and separate from small diameter powder 130A, depicted as a volume under print 240A containing large diameter powder 120A and small diameter powder 130A.

The detail of dose 210A falling onto hopper 230A is shown in FIG. 1A(ii), where graphic 250A depicts a surface of a previously processed printed surface 270A which contains elevated regions (humping) and depressed regions (dipping), e.g. nonuniformities, on a prior processed feature. The small diameter powder 130A provided in dose 210A is dosed by dosing head 200A (FIG. 1A(i)) to fill in dips or depressions and load humped or elevated regions to allow a uniform spread by 140A during its passage over this region. Both the humping and dipping areas are commonly smaller than the diameter of 120A but are still generally comparable or larger than the diameter of 130A, allowing 130A to uniformly level these nonuniformities.

FIG. 1A(iii) illustrates graphic detail 290A, where volume under print 240A seen in FIG. 1A(i) interacts with small diameter powder 130A. Small diameter powder 130A particles are on the left in (290A) and absent on the right. When small diameter powder 130A is absent (right image of 290A), only large diameter powder 120A is present on either previously processed surface 180A or bare print plate 190A. Typically, the HFL 230A interacts with large diameter powder on the area of the print bed with previously printed features by reflecting once or twice before interacting with previously printed features 300A with a minor amount of absorption per bounce. In various implementations the absorption into previously printed features with small diameter powder present 120A can lead to initially melting the area. This can cause wetting of other previously printed features as well as increasing the absorption of HFL 330A by the combined melt pool formed by the liquid phase transition the printed areas.

Materials that are applicable for these techniques can include metal, ceramic, glass, and polymer. For example, any metal obtainable in powder form (including but not limited to steels, copper, aluminum, titanium, tungsten, various alloys, etc.) In various examples, metal powder size and can be in the sub-micron to sub-millimeter range. In other examples ceramic or glass in powder form can be used. The ceramic or glass powder can be composed of materials that have a close glass transition temperature. Powder size for glass or ceramic powders can be in the sub-micron to sub-millimeter range. In the plastic category, any of the semi-crystalline polymers can be utilized (including but not limited to polyamides, polystyrenes, polypropylenes, thermoplastic elastomers, and polyaryletherketones) and plastic powder size can be in the sub-micron to sub-millimeter range.

FIG. 1B (i) illustrates an example of vibrational agitators 100B on the hopper and dosing head for improved powder flow and dosing control. The powder hopper 110B contains powder 120B to be dosed by a dosing head 130B onto the build plane. The dosing applies a dose 140B. A precise and controlled amount of powder 120B is deposited where needed on a build plane (not shown). A vibrational head 150B is provided to reduce potential for clumping and nozzle clogging of the powder in the hopper and as it passes though the nozzle in dosing head 130B. The vibrational head 150B can be attached to the powder hopper 110B and acts to impart vibrational energy into the hopper which couples into powder 120B and causes vibrational motion to disperse the powder clumping that happens in the hopper. Since clumping in the hopper limits powder from flowing into the dosing head 130B. The reduction of clumping can improve dosing capabilities. In some embodiments, another vibrational head 160B can be used alone or in addition to vibrational head 150B. In those embodiments, powder flows out of the hopper and into 130B where it is incorporated into dosed amount 140B by the mechanism within dosing head 130B. The powder can form clusters or aggregates in the process of flowing or metering within dosing head 130B resulting in clogging. To mitigate this clumping possibility, a vibrational head 160B can be attached to the dosing head or be incorporated as part of the dosing mechanism to perturb and enhance the flow of the powder into dose 140B.

Detail of the vibrational effect on dose 140B is shown in graphic 170B where detail of tip 180B is shown in. The tip 180B shows vibrational actuation internal to the dosing head 130B at the tip 180B, with the volume affected in the tip of the dosing head 200B. A channel in which powder flows into an exemplary dosing mechanism 210B and 230B can be directly or indirectly coupled to the vibrational activation imparted to this mechanism or to dosing head 200B by the vibrational head 160B. The dosing mechanism creates precise dosed portions of powder while being activated by the vibrational head 160B. While the screen or gate structure 230B can change dose by opening or closing this channel, the vibrational actuation could be a dither or additional higher frequency harmonic, causing local and rapid agitation of the tip 180B to prevent local clumping and aid in powder flow through the dosing mechanism.

In the various embodiments a vibrational transducer for vibrational head 150B or 160B can be any one of many types of vibrational agitators such as voice coils, reciprocating linear stages, modified shake table, piezo-electric, capacitive, magnetostrictive, or ultrasonic transducer. The vibrational frequencies that can be imparted to the hopper can be as low as 10 Hz (in the case for shake tables, voice coils, and reciprocating stages) to hundreds of Hertz (in case of voice coils and reciprocating stages) to KHz (voice coils, piezo-electric, capacitive, and magnetostrictive transducers) to hundreds or thousands of kilo-Hertz (for piezo-electric, capacitive, magnetostrictive, and ultrasonic transducers). The force applied to the hopper by the vibrational transducers can range from micro-Newtons to tens of Newtons.

FIG. 1C(i) illustrates an example of using a z-axis stage 100C as a method for spreading and compaction. In this embodiment a build plate 110C supports previously printed parts/volumes 120C and provides a surface on which a dosed powder 170C can be deposited. To accommodate dosed powder 170C and set the system up for spreading, the build plate 110C is moved downward by a distance 190C into the build volume so that the roller 150C is tangent to the build wall 130C during the lateral motion 160C during the spread process. The spreading process uses the roller 150C as a blade by rotating in the opposite direction to lateral motion 160C so that its leading edge minimally interacts with the dosed powder 170C. This action sweeps the dosed powder 170C to form a plane of powder of uniform thickness 140C and is limited by the height of the top edge of the build wall 130C. The downward distance 190C that 110C is reduced into the build volume equals the non-compacted volume of loose powder that could free and uniformly occupy this volume and which is created by the action of the roller 150C on the dosed powder 170C with linear motion 160C.

Compaction of this volume requires that roller 150C interacts with the plane of powder of uniform thickness 140C as seen in FIG. 1C(ii). This typically requires a change in its motion during the compaction process to (as shown by 200C) while undergoing a similar change of direction 230C. Prior to the compaction process, the loosely filled volume defined by the spreading process and the plane of powder of uniform thickness 140C needs to be lifted out of the build volume by an amount 210C equal to the compaction volume by adjusting the z-axis stage 100C upwards by a specified distance 240C. The roller 200C is now rotating in the direction 230C of compaction motion so that when it interacts with 220C, the powder is compressed down to 130C level.

The powder can be any one of the types and distributions previously described. The roller can be constructed from a material that is at least as hard as the powder being worked and manufactured to a finish that is a function of the powder distribution being worked. Use of the z-axis stage allows a repeatable spread and compaction process on every cycle during the build.

FIG. 1D(i-iii) illustrate an example embodiment supporting vibration packing for print compaction on a print bed 100D. Vibrational energy is injected into the print bed 100D and uses the previously printed structures as secondary actuation structures to aid in powder compaction through a sedimentation process. The print bed 100D contains a build well 115D with a top surface plane 110D that defines the nominal blade plane for powder spreading. Within the build well 115D and below the top surface plane 110D are previously printed volume/parts 120D attached to a build plate 130D. A z-axis stage 140D regulates the height above or below the top surface plane 110D for dosing and spreading functions. Coupling of vibrational energy is performed by attachment of a vibrational head 150D onto z-axis stage 140D producing vibrations in the z-axis stage 140D, the build plate 130D and the printed volume/parts 120D. The vibrational directions are not limited to in plane only as depicted but can take on any direction in and out the plane of the depiction. In an alternative embodiment the vibrational head 150D can be attached to the build plane directly. In examples where the vibrational head is directly attached to the build plane the vibrational directions are not limited to direction noted. In a further embodiment the vibrational head 150D can be incorporated into the body of the build plate itself and orientated in any direction. The vibrational head can produce a set of complex motions not limited in any one or more directions.

Powder 183D can be dosed on top of 120D (shown in detail in FIGS. 1D(ii) and 1D (iii)). In embodiments without vibration support, a powder 200D distribution occupies the previously printed features 210D (shown in detail 190D in FIG. 1D(ii)) randomly with minimal packing density resulting in voids upon the next pass with the laser. When excitation is applied to the build plate and in turn to the previously printed features, this mass directly couples into the powder (depicted in detail respect to 220D in FIG. 1D(iii)) and reorders the powder by sedimentation process by which small particles work themselves down and in between large particles (depicted in detail with respect to 230D) fill the available volume. This results in greater dense packed powder volume and results in less defects in the printed part. Typically, use of such a sedimentation process involves multi-axes excitation 240D and 250D.

FIGS. 1E(i-iii) illustrates an example of a structured roller for a powder spreading system 100E. In this embodiment, a powder bed surface 110E can be a reference plane for a structured roller 150E. A build plate 120E has a volume 130E of previously printed parts connected to it as it rises or lowers on the z-axis stage 140E. The stage 140E is lowered to a level so that powder can be dosed onto the volume 130E of previously printed parts in a pile of powder 165E prior to spreading by the structured roller 150E which can be set to rotate counter to spread direction. In this case, structured roller 150E can contain a structured surface e.g. a first structured surface 190E seen in FIG. 1E(ii), a second structured surface 200E seen in FIG. 1E(ii), a third structured surface 230E seen in FIG. 1E(iii), and a fourth structured surface 260E seen in FIG. 1E(iii). In an implementation, a plurality of structured surfaces can be applied to 150E, for example first structured surface 190E and second structured surface 200E with features in a diagonal linear pattern (e.g. first structured surface 190E) or a crosshatch pattern (e.g. second structured surface 200E) with pattern being dependent on the particle shape, size and distribution. Detail of the patterned roller can be seen (for example with reference to end detail 210E) with detail of the structure 220E that makes up the pattern on the roller. In a first example the roller has a first structure 230E. In a second example the roller has a second structure 260E.

Detail 230E is exemplary of extended surface structures such as embedded brushes, screens, rakes etc. 240E attached to the surface of the roller. The length 250E of the embedded brushes, screens, rakes etc. are related to the average size and distribution of the powder that one or more of the embedded brushes, screens, rakes etc. are intended to interact with during the spreading process. In an example the brush material can be composed of fiber and/or strips of carbon fiber, metals, ceramics, elastomerics and thermoplastics. In a further example, screens and rakes can be composed of similar materials to brushes but with shape features that extend outward from the structured roller 150E. Shape features can be dependent on the powder's material characteristics along with bed and printing environmental parameters. The powder characteristics can include, for example, density, mass, shape, surface roughness and chemical make-up. The bed and printing parameters can include, for example, the bed temperature, the gas flow mixture used, its flow speed and its atmospheric pressure and temperature during spreading operation by the structured roller 150E.

Removed surface structures (e.g., 260E) such as teeth, divots, scallops, or microscopic and nanoscopic surface relief features 270E can act as miniature blades in the patterns shown as first surface structure 190E and second surface structure 200E (as examples). The depth of the teeth or sculptured structures can be related to the average size and distribution of the powder it is meant to interact with during the spreading process. Additionally, the use of microscopic and nanoscopic relief features can be used to modify the surface energy of structured roller 150E to allow a powder-phobic response. This surface modification can be used in conjunction with the macroscopic surface relief patterns (teeth) or as a stand-alone surface modification and would prevent powder from sticking or attaching itself to structured roller 150E through any Van der Waal like forces (stiction). This stiction prevention reduces the build-up of fine soot or powder that might otherwise compromise the spreading process or longevity of the roller.

FIGS. 1F(i-iii) illustrates an example of powder sifting roller structures for micro-dosing and spreading. The top of a build wall 110F can set a reference plane for the roller and for the top surface of the power after spread. A build plate 120F contains previously printed parts and volumes 130F and is adjusted in height by a z-axis stage 140F (e.g., upward or downward). A roller 160F rotates in a counter direction 180F to that of a direction of spread 190F of a dosed pile of powder 170F. The resulting spread of the powder 170F forms a planar powder surface 205F. The roller 160F can be constructed so that powder can be introduced to the roller by feeding a smaller diameter powder internal to the roller and this powder is released during the rotation of the roller through features on the surface. The features can be of many variations for example, first feature 270F and second feature 290F. First feature 270F can be, for example, linear cuts. Second feature 290F can be, for example, an array of holes. The micro-dosing 200F at the interaction point between the roller 160F and the dosed pile of powder 170F. This is shown in detail as 210F. As 160F rotates through a rotational direction while being moved in a linear direction across the build wall 110F, the small diameter powder 220F that is fed internally to the roller 160F is dosed out through features in the surface of the roller 160F as depicted in a further example 230F. This micro-dosing 200F is sifted onto the spread and compacted surface which initially contains just the large diameter powder 250F of the dosed pile of powder 170F by with this action contains interspersed with the micro-dosed powder. The features of linear cuts 270F or an array of holes 290F are shown in cross-sectional detail 300F of depicting the slotted nature 310F with the small diameter powder 320F held within.

Additionally, if the features 300F are sized to the dosed pile of powder 170F, then this method could be used to redistribute the dosed pile of powder 170F during spreading and compaction by picking powder from the dosed pile of powder 170F on the leading edge of roller 160F during the rotation 180F of roller 160F and distribute by the trailing edge trailing edge. Additionally, by adjusting the pattern and shape of the features, this distribution can be adjusted to compensate for the natural tendency of spread to be thinned towards the edges and more concentrated towards the center of the volume 130F.

FIGS. 1G(i-ii) illustrates an embodiment of a system 100G that supports an ultrasonic agitated blade 130G for better powder spreading uniformity. In this embodiment, the hopper 110G contains powder 120G. A blade is attached to the bottom portion of the hopper containing powder 110G. The hopper and blade are moved in a first direction 115G relative to a stationary build plate 140G. The placement for the ultrasonic agitated blade 130G can be located at a variety of different locations and the location depicted here is an exemplary version. The build plate 140G can contain a previously printed volume 150G on which previously spread powder 210G and dosed powder 190G was applied through a dosing head 180G into a pile of powder 200G prior to be activated by 130G. An ultrasonic agitator 160G is attached to the blade 130G and activated along direction of motion 170G. Besides attaching directly to 130G, 160G can be attached to 130G's support structures while the activation power can be applied directly to 130G by way of acoustical couplings.

Detail on how this embodiment enables better spreading is depicted 220G and in detail 230G. Detail 230G depicts 130G's tip region 240G which includes actuation features on 130G's tip. These features can be composed of brushes, rakes, meshes or any of the number of actuation features 250G described with reference to FIG. 1E with material types previously mentioned. The acoustical energy injected into blade 130G by ultrasonic agitator 160 in a direction of motion 170G causes tip region 240G to oscillate in one or more directions (L-R in plane, up-down in plane, or out of plane). In the embodiments herein described this is depicted as L-R in-plane motion 290G, however this should not be considered as limiting and the blade may move in any direction of oscillation. These oscillations can be in each of the noted direction or in combination of directions. The action of these oscillations imposed on actuation features 250G via tip region 240G and blade 130G operates on the pile of powder 200G. The oscillations 290G locally agitate the powder 280G causing it to change it from a stable pile to a region of random surface variability 270G as blade 130G is moved in the direction 115G The random oscillations 290G reorder the powder within region of random surface variability 270G to create a uniform surface depicted in detail 260G and which becomes flat and relatively uniform area 210G.

FIGS. 1H(i-iii) illustrate an embodiment using a hopper system 110H including a lopped screen or mesh as a spreader and micro-doser. The hopper system 110H contains powder that can be moved in the direction of 115H with respect to the build plate with previously printed volumes and on which a dosed pile of powder 120H has been placed. This embodiment includes a looped mesh/screen assembly that is composed of a reel-out and pickup wheels 130H, a length of mesh 140H that is controlled using tensioners rollers 150H to form an open loop of the mesh/screen as it interacts with 120H at detail 160H as shown in FIG. 1H(ii). The detail of interaction between 120H and 140H is exemplified by 170H. The loop of mesh is shown in detail as 180H with two examples of the mesh being 220H and 230H shown in FIG. 1H(iii). The mesh pores are sized so that the powder distribution in 120H can freely enter the open loop as the mesh is moved along 115H with the hopper. The lopped tangent edge of the loop acts as a blade to spread 120H while the mesh openings perform a sieving action by micro-dose the smaller diameter aspect of the powder distributions among the larger diameter aspects while spreading both.

FIG. 1I illustrates an example of a system 100I using a vacuum driven layer control to achieve uniform spread layers. A hopper 1101 containing powder is moved in the direction of 115I with respect to the build plate with previously printed volumes and on which a dosed pile of powder 120I has been placed. The blade of FIG. 100I pushes 120I to create a thick layer of powder with the intention that this layer is thick enough that the spread quality is not constrained by print bed 150I or the powder size distribution 120I. Following behind spreader blade 130I is a nozzle which has been engineered to provide even powder suction along the length of the print bed 150I. The proximity of the nozzle to 150I defines the layer thickness 250I. This embodiment is not influenced by print bed 150I and is not constrained by powder viscosity issues that can arise if spreader blade 130I is pushing a powder layer that is thin relative to print bed 150I or the powder size distribution. This embodiment can eliminate the so-called “ocean wave” effect observed in spread layers where a slight bump in powder is observed where spread powder layer transitions from deep powder to print bed 150I and likewise a slight valley when spread transitions from print bed 150I to deep powder.

FIG. 1J illustrates an embodiment of a system 100J using electrostatic driven layer control to achieve uniform spread layers. A hopper 110J containing powder is moved in the direction of 115JI with respect to the build plate with previously printed volumes and on which a dosed pile of powder 120J has been placed. The blade of 100J pushes a dosed pile of powder 120J to create a thick layer of powder with the intention that this layer is thick enough that the spread quality is not constrained by print bed 150J or the powder size distribution of the dosed pile of powder 120J. Following behind spreader blade 130J is an electrostatically controlled roller 250J whose charge, proximity, and roll speed define the amount of powder remaining to create the final spread layer 260J. A nozzle 230J pulls the removed powder 240J from the roller to prepare the roller surface to continue the process. This embodiment is not influenced by print bed 150J and is not constrained by powder viscosity issues that can arise if spreader blade 130J is pushing a powder layer that is thin relative to print bed 150J or the powder size distribution. This embodiment can eliminate the so-called “ocean wave” effect observed in spread layers where a slight bump in powder is observed where spread powder layer transitions from deep powder to print bed 150J and likewise a slight valley when spread transitions from print bed 150J to deep powder.

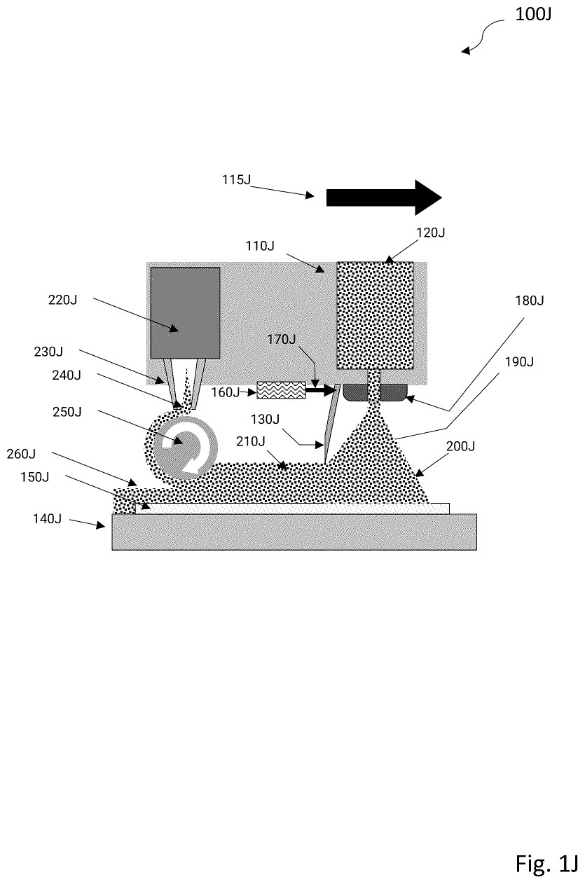

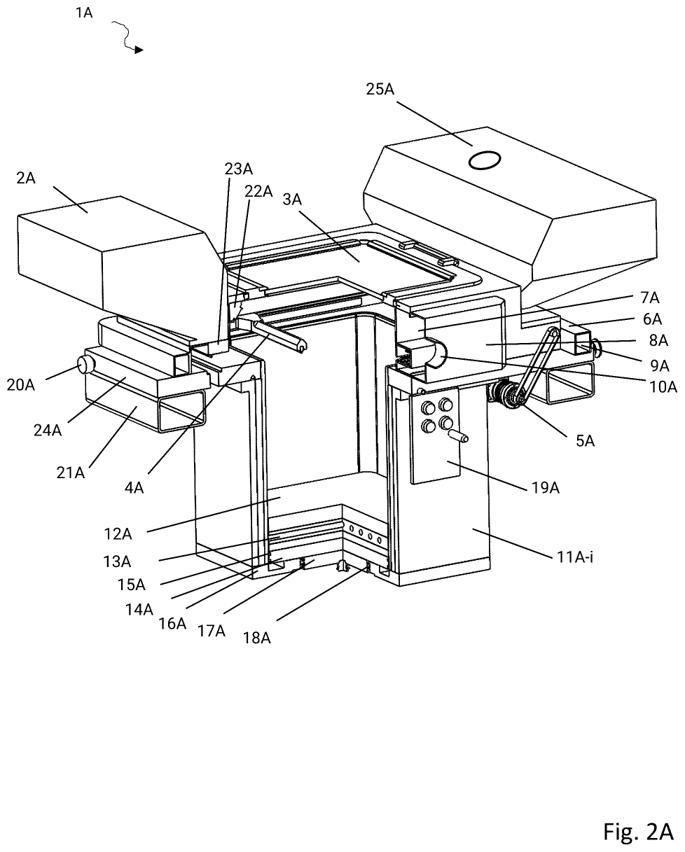

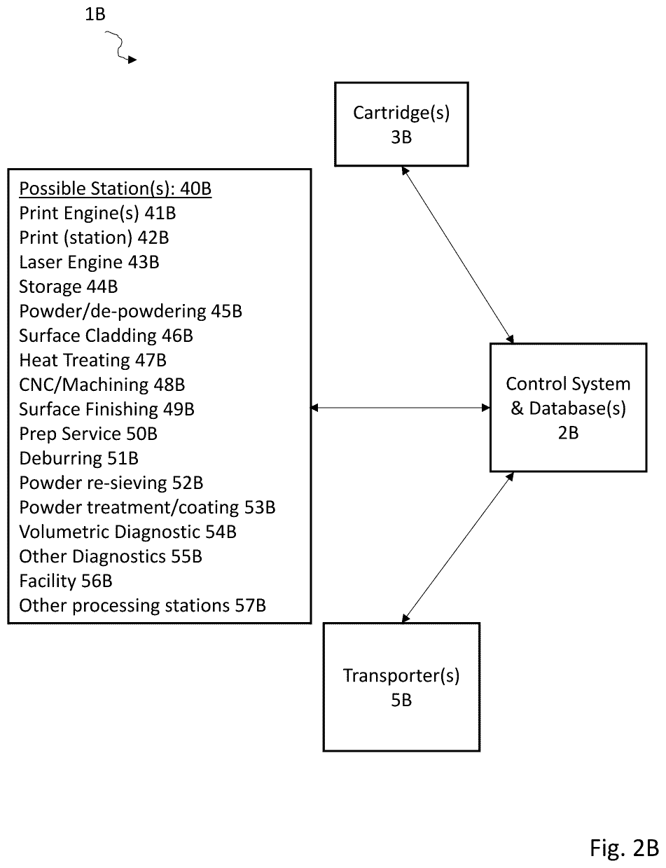

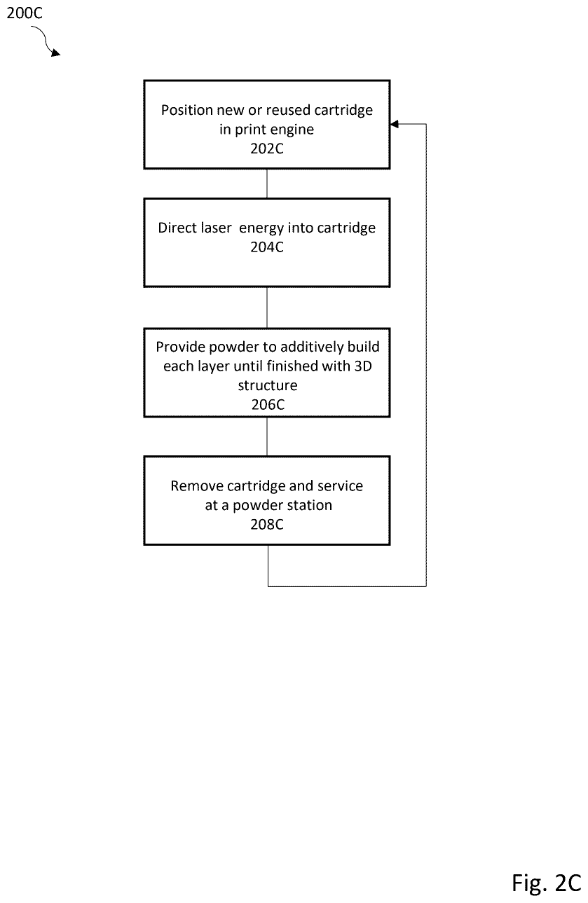

FIG. 2A illustrates in partial cross section a 3D print cartridge 1A for holding new or recycled powder that can be optionally handled and dispensed using vibratory assistance in accordance with this disclosure for an additive manufacturing system. The 3D print cartridge (hereinafter “cartridge”) separates all of “dirty” printing functions from the rest of the system and the operator environment and is designed for replacement or removal. “Dirty” means wherever powder is present, processed for printing, or soot is generated. Whenever the cartridge 1A is connected to mating equipment such as a station (printer, de-powder, or storage) to be later described, the mating equipment can supply services required to operate the cartridge as needed based on which station it is mated to (e.g. the printer station allows full control of the cartridge while the storage station may only provide heating, power, and gas recycling, and use of the camera and lights). The cartridge 1A is designed to be sealed when disconnected from a mating station.

The cartridge 1A is built around a bed or base plate 24A. Fresh powder for a new print is stored in the powder hoppers 2A which can have the capacity to store all the powder needed for a full volume print. Fresh powder is metered onto the base plate 24A through the powder door 23A. Powder is swept across the plate by a powder spreader 4A using powder spreading blade(s). The powder spreader drive 5A moves the powder spreader back and forth across the print plate 12A.

A window 3A seals the top of the cartridge 1A against leaks of powder or gas and allows a laser beam (not shown) to pass through it to weld powder. The window 3A allows the access to the cartridge for loading print plates, unloading prints, cleaning and servicing the cartridge components (seals, spreader blades etc.). The inside of the cartridge 1A can be illuminated and imaged by the camera and lights 22A. The camera and lights can be either inside or outside the sealed chamber, or both, and can be positioned to take pictures and/or focus on scenes on the inside of the cartridge, in particular the print plate. The camera and lights can also be mounted on motion stages allowing the user to pan or zoom on items of interest during a print. This camera can be combined with secondary print diagnostics such as pyrometers, motion detectors, photodiodes, thermal cameras, or other sensors to automatically detect events and pan/zoom the camera to focus on the location of interest. In some embodiments, camera images can be viewed by the operator in an electronic or virtual window instead of directly viewing through a physical port or window in the cartridge.

Inert gas can be supplied to the cartridge by a gas supply duct 6A so that printing can be performed in whatever atmosphere is best for each print. The gas return duct 7A removes inert gas. The gas passes through the HEPA filter 8A which removes impurities (soot, suspended nano particles of powder, etc.). The gas then travels to a gas recycler (not shown) which is installed on mating equipment. When the cartridge is disconnected from mating equipment, a gas supply port 9A and a gas return port 10A are sealed to preserve the atmosphere inside the cartridge. Gas is subsequently purified by removing oxygen, moisture, etc. by other equipment.

The Z-axis lowers the print plate after each layer is printed so that a new layer of powder can be spread and subsequently printed. A Z-axis frame 11A holds the Z-axis components in this design. The print plate (AKA build plate) 12A is where powder is welded during printing. The print plate heater 13A contains a heating mechanism for the print plate 12A (if desired) and can also insulate and/or cool a seal plate 14A. The seal plate 14A carries seals 15A, which confines the powder to the Z-axis frame 11A. The Z-axis bottom plate 16A closes off the lower end of the Z-axis frame 11A and has features to contain any powder that may slip past the seals 15A. The plunger 17A has an interface so that it can remotely, automatically, and accurately interface with the Z-axis drive. A plunger seal 18A mates with the bottom plate 16A and further seals the cartridge 1A against powder and/or gas leaks.

An interface plate 19A contains all the inputs and outputs for the cartridge (compressed air, power, input and output signal, gas, cooling water, etc.). It is designed to make all these connections when the cartridge is connected to mating equipment. The interface can also contain a mechanism to electronically identify each cartridge when mated with mating equipment. Rollers 20A allow the cartridge 1A to be rolled onto the mating rails of mating equipment. Forklift tubes 21A allow the cartridge to be picked up and moved by a forklift or other transporter system.

In another embodiments, the interface plate can be configured to mate to various types or models of printers.

In one embodiment, drive components (such as motors, actuators, etc.) can be located in the mating stations and employ linkages to transfer power from the external drive components to driven components inside the cartridge. This will reduce the cost and complexity of each cartridge. For instance, the powder spread drive 5A, can be coupled to a linkage structure that is automatically connected when the cartridge is connected into the print station/engine through a gearing system, a belt system (shown in 5A), a magneto-restrictive, electrical, magnetic, inductive, hydraulic or other similar types of signal or energy transfer. Likewise, gas and fluid exchange between the cartridge and any compatible mating station could have external powder, fluid and/or gas pumps that can hook into the cartridge at either the interface panel 19A or other convenient locations that can allow transfer of powder (into hoppers 2A), fluid or gas without the need to over burden the cartridge with internal service transfer motors/pumps. Internal impellers (used to transfer powder and fluid) can be powered from external motors via aforementioned linkages.

Power coupling through the interface panel 19A can be electrical, inductive or optical with the latter two allowing for both power and communications to be transferred simultaneously. Additionally, diagnostic information from the various sensors built into the cartridge can occur via electrical, or optical methods.

In one embodiment, the cartridge 1A can include electronic identification such as an electronically readable memory 25A or other electronically readable indicia such as attached text, QR codes, or bar codes. The memory 25A can provide electronic information about the cartridge or cartridge components can be used to identify its make, model, type, powder type, or any other defining details about the unit, its sub-components, or their intended uses. This information can be used to inform a print engine about what material is to be printed, desired atmosphere (pressure and temperature), or other print related aspect so the print engine can adapt as needed to accommodate the print cartridge, or sub-assembly. The change induced could involve an action such as the automatic swapping of internal lens assemblies, adjustment of z-height/final optical throw of the lens assembly, laser parameter adjustment such as power per unit area, pulse shape, pulse duration, pulse repetition rate, wavelength, spatial pulse shape, tile size, spatial energy distribution within a tile, modify data diagnostics, data feedback algorithms, print process feedback algorithms, or algorithmic change to how tiles are put down during the print process. Electronic information from electronic memory 25A that is associated with a print cartridge can be read by any of the stations to collect data on how much printing has occurred and other key metrics such as number of spreader cycles, z-axis adjustments, temperature cycles, pressure cycles, or other attribute that the cartridge or sub-cartridge have undergone along the way. This information can also be stored in a central database by any of the stations, one of the subsystems, the factory automation system, the cartridge itself, the cartridge transport system or other mating/interfacing equipment.

FIG. 2B illustrates an additive manufacturing system 1B that includes a variety of potential stations. In some embodiments a removable cartridge is loaded into a station. An example of a station can be the cartridge-equipped print station in which energy (laser or electron beam) is delivered into it from a laser engine (station) to enable it to print a part. Typically, a laser engine is only used in conjunction with a print station to turn the combination into a print engine. The stations can be arranged and connected to each other to form a manufacturing system. A manufacturing system may contain many cartridge-equipped stations, and support stations captured in a frame arrangement, coordinated by a control system and which takes print instructions from the user in order to fulfil print orders/jobs. These other functional stations can contain dirty processes to reduce human exposure in making a 3D part. As mentioned before, 3D printing is of itself messy, equally messy is the pre- and post-processing of the cartridge, post-processing of the powder and post processing of the printed part. Additionally, the cartridge system interface for interaction with various diagnostics systems. The control system and database(s) 2B can communicate with the cartridge separately or when it is connected to any one of the listed station(s) 40B or while it is being manipulated by the transporter 5B. The station(s) listed is not an all-inclusive list but do include the print engine 41B (composed of a print station 42B and a laser engine 43B), a storage (rack) station 44B, a facility station 56B, and a powder prep/de-powdering station 45B. The powder prep station could be one station for prepping a cartridge which can include removing powder from a cartridge that already had undergone printing. These two functions (prepping a cartridge and powder removal) could be done in one station or two separate in which case the prepping station could be called ‘prep’ while the other could be called ‘de-powdering’. The other stations can include surface cladding station 46B, heat treating station 47B, CNC/machining station 48B, surface finishing station 49B, a prep service station, a de-burring station, a powder re-sieving station 52B, a powder surface treatment/coating station 53B, the diagnostic station 54B, other volumetric and surface diagnostic station 55B, and other processing station 56B. The laser engine 43B mates to and interacts with the print station 42B (to form a print engine 41B), the surface cladding station 46B, the diagnostic station 54B, and may interact with heat treating station 47B and the surface finishing station 49B.

The print station 42B, the surface cladding station 46B, the heat-treating station 47B, the CNC/machining station 48B, the surface finishing station 49B, and the deburring station 51B does post processing on the printed part. The surface cladding station 46B in conjunction with the laser engine 43B operates on the printed part to add a functional layer to selected surfaces as in the case of drill bits, airfoil surfaces, turbine blades or medical implants. The heat-treating station 47B, in conjunction with the laser engine 43B can perform surface annealing and hardening or it can do this form of post processing using other traditional methods such as standard thermal sources or directed energy non-laser sources. The CNC/machining station 48B performs standard subtractive manufacturing on a printed part for final figure and form. The surface finishing station 49B can interact with the laser engine 43B to perform surface smoothing via mass transport/surface tension, or laser peening/hardening. The surface finishing station 49B can also be performed in more traditional subtractive methods as well (this does not require coupling 49B to 43B). The deburring station 51B can use traditional subtractive machining methods to enhance surface finish of the printed part. The diagnostic station 54B can couple with the Laser Engine 43B to volumetric scan the printed part to ensure print accuracy, density, and defect statistics. Additionally, volumetric or other diagnostics (54B and 55B, respectively) can be used in conjunctions with a storage station and Laser Engine to determine functionality of the printed part under conditional environments such as high or low heat, high pressure or partial vacuum, or other environmental or operation extremes to ensure the printed part can withstand static operational performance requirements.

The prep service station 50B is used to service the cartridge and may be used in conjunction with the powder station 45B and facility station 56B. In the prep station, consumables are replaced in a manner to minimize human interaction with the dirty environments. Gases and fluids are removed for post processing via the facility station 56B. Used powder is removed and transferred to the powder re-sieving station 52B for powder recovery.

The powder treatment/coating station treats the powder for chemistry or emissivity enhancements, this can depend on which powder/metal is being used but could include chemical or oxide treatment to enhance emissivity (such as increasing the absorption of copper or steel by surface treatment of the powder) of by adding chemical dopants to the powder for special print parameters.

Other diagnostics station 55B can include x-ray tomography, surface scanning imaging, high resolution surface and thermography imaging to name a few in which the printed part is manipulated while minimizing handling damage and not exposing the human to dangerous metrology methods (as in the x-ray tomography case).

The other processing stations can allow customer needs to be met by isolating potentially dangerous process, test or diagnostics processes from workers and/or the printed part.

FIG. 2C illustrates a process flow 200C for operation of a cartridge based additive manufacturing system using powder created or recycled as discussed in this disclosure. In step 202C, a new or reused removable cartridge is positioned in a print engine. In step 204C, laser energy is directed into the cartridge to build a 3D part. In step 204C, laser energy is directed into the cartridge to fuse, sinter, melt or otherwise modify a powder layer. In step 206C, additional powder is positioned and subjected to laser energy, with the process additively repeating to build each layer and produce a 3D print structure. In step 208C the cartridge can be removed and serviced at a separate powder handling station. Again, powder created or recycled as discussed in this disclosure can be used to fill the cartridge. The serviced cartridge or a fresh cartridge can be positioned in the print engine for manufacture of additional or new 3D prints.

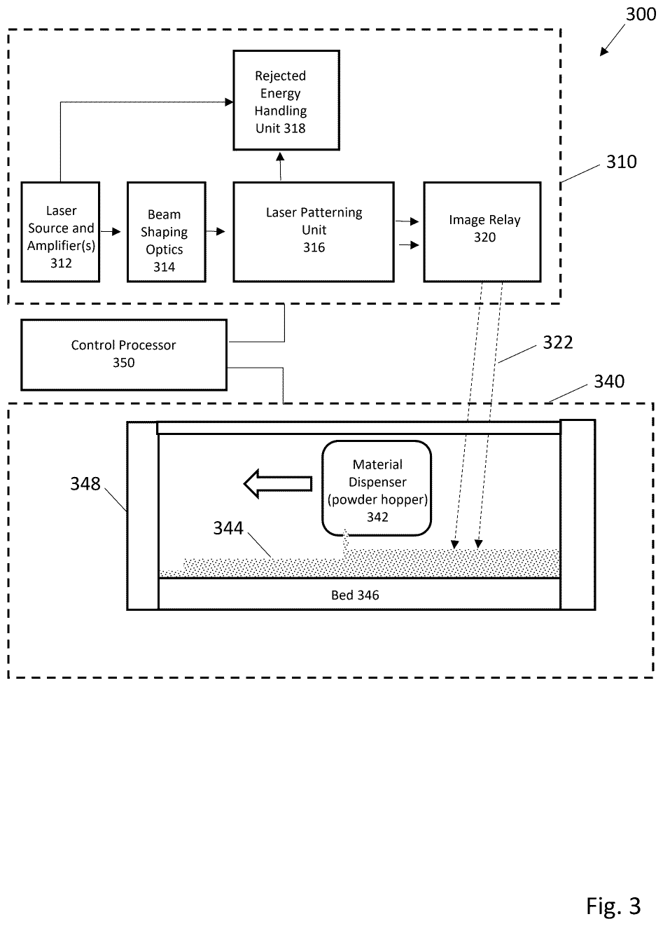

In another embodiment illustrated with respect to FIG. 3, additive manufacturing systems can be represented by various modules that form additive manufacturing method and system 300. As seen in FIG. 3, a laser source and amplifier(s) 312 can be constructed as a continuous or pulsed laser. In other embodiments the laser source includes a pulse electrical signal source such as an arbitrary waveform generator or equivalent acting on a continuous-laser-source such as a laser diode. In some embodiments this could also be accomplished via a fiber laser or fiber launched laser source which is then modulated by an acousto-optic or electro optic modulator. In some embodiments a high repetition rate pulsed source which uses a Pockels cell can be used to create an arbitrary length pulse train.

Possible laser types include, but are not limited to: Gas Lasers, Chemical Lasers, Dye Lasers, Metal Vapor Lasers, Solid State Lasers (e.g. fiber), Semiconductor (e.g. diode) Lasers, Free electron laser, Gas dynamic laser, “Nickel-like” Samarium laser, Raman laser, or Nuclear pumped laser.

A Gas Laser can include lasers such as a Helium-neon laser, Argon laser, Krypton laser, Xenon ion laser, Nitrogen laser, Carbon dioxide laser, Carbon monoxide laser or Excimer laser.

A Chemical laser can include lasers such as a Hydrogen fluoride laser, Deuterium fluoride laser, COIL (Chemical oxygen-iodine laser), or Agil (All gas-phase iodine laser).

A Metal Vapor Laser can include lasers such as a Helium-cadmium (HeCd) metal-vapor laser, Helium-mercury (HeHg) metal-vapor laser, Helium-selenium (HeSe) metal-vapor laser, Helium-silver (HeAg) metal-vapor laser, Strontium Vapor Laser, Neon-copper (NeCu) metal-vapor laser, Copper vapor laser, Gold vapor laser, or Manganese (Mn/MnCl₂) vapor laser. Rubidium or other alkali metal vapor lasers can also be used. A Solid State Laser can include lasers such as a Ruby laser, Nd:YAG laser, NdCrYAG laser, Er:YAG laser, Neodymium YLF (Nd:YLF) solid-state laser, Neodymium doped Yttrium orthovanadate (Nd:YVO₄) laser, Neodymium doped yttrium calcium oxoborateNd:YCa₄O(BO₃)₃ or simply Nd:YCOB, Neodymium glass (Nd:Glass) laser, Titanium sapphire (Ti:sapphire) laser, Thulium YAG (Tm:YAG) laser, Ytterbium YAG (Yb:YAG) laser, Ytterbium: 2O₃ (glass or ceramics) laser, Ytterbium doped glass laser (rod, plate/chip, and fiber), Holmium YAG (Ho:YAG) laser, Chromium ZnSe (Cr:ZnSe) laser, Cerium doped lithium strontium (or calcium)aluminum fluoride (Ce:LiSAF, Ce:LiCAF), Promethium 147 doped phosphate glass (147Pm+3:Glass) solid-state laser, Chromium doped chrysoberyl (alexandrite) laser, Erbium doped and erbium-ytterbium co-doped glass lasers, Trivalent uranium doped calcium fluoride (U:CaF₂) solid-state laser, Divalent samarium doped calcium fluoride (Sm:CaF₂) laser, or F-Center laser.

A Semiconductor Laser can include laser medium types such as GaN, InGaN, AlGaInP, AlGaAs, InGaAsP, GalnP, InGaAs, InGaAsO, GaInAsSb, lead salt, Vertical cavity surface emitting laser (VCSEL), Quantum cascade laser, Hybrid silicon laser, or combinations thereof.

As illustrated in FIG. 3, the additive manufacturing system 300 uses lasers able to provide one- or two-dimensional directed energy as part of an energy patterning system 310. In some embodiments, one dimensional patterning can be directed as linear or curved strips, as rastered lines, as spiral lines, or in any other suitable form. Two-dimensional patterning can include separated or overlapping tiles, or images with variations in laser intensity. Two-dimensional image patterns having non-square boundaries can be used, overlapping or interpenetrating images can be used, and images can be provided by two or more energy patterning systems. The energy patterning system 310 uses laser source and amplifier(s) 312 to direct one or more continuous or intermittent energy beam(s) toward beam shaping optics 314. After shaping, if necessary, the beam is patterned by an energy patterning unit 316, with generally some energy being directed to a rejected energy handling unit 318. Patterned energy is relayed by image relay 320 toward an article processing unit 340, in one embodiment as a two-dimensional image 322 focused near a bed 346. The article processing unit 340 can include a cartridge such as previously discussed. The article processing unit 340 has plate or bed 346 (with walls 348) that together form a sealed cartridge chamber containing material 344 (e.g. a metal powder) dispensed by powder hopper or other material dispenser 342. Dispensed powder can be created or recycled as discussed in this disclosure. Patterned energy, directed by the image relay 320, can melt, fuse, sinter, amalgamate, change crystal structure, influence stress patterns, or otherwise chemically or physically modify the dispensed and distributed material 344 to form structures with desired properties. A control processor 350 can be connected to variety of sensors, actuators, heating or cooling systems, monitors, and controllers to coordinate operation of the laser source and amplifier(s) 312, beam shaping optics 314, laser patterning unit 316, and image relay 320, as well as any other component of system 300. As will be appreciated, connections can be wired or wireless, continuous or intermittent, and include capability for feedback (for example, thermal heating can be adjusted in response to sensed temperature).

In some embodiments, beam shaping optics 314 can include a great variety of imaging optics to combine, focus, diverge, reflect, refract, homogenize, adjust intensity, adjust frequency, or otherwise shape and direct one or more laser beams received from the laser source and amplifier(s) 312 toward the laser patterning unit 316. In one embodiment, multiple light beams, each having a distinct light wavelength, can be combined using wavelength selective mirrors (e.g. dichroics) or diffractive elements. In other embodiments, multiple beams can be homogenized or combined using multifaceted mirrors, microlenses, and refractive or diffractive optical elements.

Laser patterning unit 316 can include static or dynamic energy patterning elements. For example, laser beams can be blocked by masks with fixed or movable elements. To increase flexibility and ease of image patterning, pixel addressable masking, image generation, or transmission can be used. In some embodiments, the laser patterning unit includes addressable light valves, alone or in conjunction with other patterning mechanisms to provide patterning. The light valves can be transmissive, reflective, or use a combination of transmissive and reflective elements. Patterns can be dynamically modified using electrical or optical addressing. In one embodiment, a transmissive optically addressed light valve acts to rotate polarization of light passing through the valve, with optically addressed pixels forming patterns defined by a light projection source. In another embodiment, a reflective optically addressed light valve includes a write beam for modifying polarization of a read beam. In certain embodiments, non-optically addressed light valves can be used. These can include but are not limited to electrically addressable pixel elements, movable mirror or micro-mirror systems, piezo or micro-actuated optical systems, fixed or movable masks, or shields, or any other conventional system able to provide high intensity light patterning.

Rejected energy handling unit 318 is used to disperse, redirect, or utilize energy not patterned and passed through the image relay 320. In one embodiment, the rejected energy handling unit 318 can include passive or active cooling elements that remove heat from both the laser source and amplifier(s) 312 and the laser patterning unit 316. In other embodiments, the rejected energy handling unit can include a “beam dump” to absorb and convert to heat any beam energy not used in defining the laser pattern. In still other embodiments, rejected laser beam energy can be recycled using beam shaping optics 314. Alternatively, or in addition, rejected beam energy can be directed to the article processing unit 340 for heating or further patterning. In certain embodiments, rejected beam energy can be directed to additional energy patterning systems or article processing units.

In one embodiment, a “switchyard” style optical system can be used. Switchyard systems are suitable for reducing the light wasted in the additive manufacturing system as caused by rejection of unwanted light due to the pattern to be printed. A switchyard involves redirections of a complex pattern from its generation (in this case, a plane whereupon a spatial pattern is imparted to structured or unstructured beam) to its delivery through a series of switch points. Each switch point can optionally modify the spatial profile of the incident beam. The switchyard optical system may be utilized in, for example and not limited to, laser-based additive manufacturing techniques where a mask is applied to the light. Advantageously, in various embodiments in accordance with the present disclosure, the thrown-away energy may be recycled in either a homogenized form or as a patterned light that is used to maintain high power efficiency or high throughput rates. Moreover, the thrown-away energy can be recycled and reused to increase intensity to print more difficult materials.

Image relay 320 can receive a patterned image (either one or two-dimensional) from the laser patterning unit 316 directly or through a switchyard and guide it toward the article processing unit 340. In a manner similar to beam shaping optics 314, the image relay 320 can include optics to combine, focus, diverge, reflect, refract, adjust intensity, adjust frequency, or otherwise shape and direct the patterned light. Patterned light can be directed using movable mirrors, prisms, diffractive optical elements, or solid state optical systems that do not require substantial physical movement. One of a plurality of lens assemblies can be configured to provide the incident light having the magnification ratio, with the lens assemblies both a first set of optical lenses and a second sets of optical lenses, and with the second sets of optical lenses being swappable from the lens assemblies. Rotations of one or more sets of mirrors mounted on compensating gantries and a final mirror mounted on a build platform gantry can be used to direct the incident light from a precursor mirror onto a desired location. Translational movements of compensating gantries and the build platform gantry are also able to ensure that distance of the incident light from the precursor mirror the article processing unit 340 is substantially equivalent to the image distance. In effect, this enables a quick change in the optical beam delivery size and intensity across locations of a build area for different materials while ensuring high availability of the system.

The material dispenser 342 (e.g. powder hopper) in article processing unit 340 (e.g. cartridge) can distribute, remove, mix, provide gradations or changes in material type or particle size, or adjust layer thickness of material. The material can include metal, ceramic, glass, polymeric powders, other melt-able material capable of undergoing a thermally induced phase change from solid to liquid and back again, or combinations thereof. The material can further include composites of melt-able material and non-melt-able material where either or both components can be selectively targeted by the imaging relay system to melt the component that is melt-able, while either leaving along the non-melt-able material or causing it to undergo a vaporizing/destroying/combusting or otherwise destructive process. In certain embodiments, slurries, sprays, coatings, wires, strips, or sheets of materials can be used. Unwanted material can be removed for disposable or recycling by use of blowers, vacuum systems, sweeping, vibrating, shaking, tipping, or inversion of the bed 346.

In addition to material handling components, the article processing unit 340 can include components for holding and supporting 3D structures, mechanisms for heating or cooling the chamber, auxiliary or supporting optics, and sensors and control mechanisms for monitoring or adjusting material or environmental conditions. The article processing unit can, in whole or in part, support a vacuum or inert gas atmosphere to reduce unwanted chemical interactions as well as to mitigate the risks of fire or explosion (especially with reactive metals). In some embodiments, various pure or mixtures of other atmospheres can be used, including those containing Ar, He, Ne, Kr, Xe, CO₂, N₂, O₂, SF₆, CH₄, CO, N₂O, C₂H₂, C₂H₄, C₂H₆, C₃H₆, C₃H₈, i-C₄H₁₀, C₄H₁₀, 1-C₄H₈, cic-2, C₄H₇, 1,3-C₄H₆, 1,2-C₄H₆, C₅H₁₂, n-C₅H₁₂, i-C₅H₁₂, n-C₆H₁₄, C₂H₃Cl, C₇H₁₆, C₈H₁₈, C₁₀H₂₂, C₁₁H₂₄, C₁₂H₂₆, C₁₃H₂₈, C₁₄H₃₀, C₁₅H₃₂, C₁₆H₃₄, C₆H₆, C₆H₅—CH₃, C₈H₁₀, C₂H₅OH, CH₃OH, iC₄H₈. In some embodiments, refrigerants or large inert molecules (including but not limited to sulfur hexafluoride) can be used. An enclosure atmospheric composition to have at least about 1% He by volume (or number density), along with selected percentages of inert/non-reactive gases can be used.

In certain embodiments, a plurality of article processing units, cartridges, or build chambers, each having a build platform to hold a powder bed, can be used in conjunction with multiple optical-mechanical assemblies arranged to receive and direct the one or more incident energy beams into the cartridges. Multiple cartridges allow for concurrent printing of one or more print jobs.

In another embodiment, one or more article processing units, cartridges, or build chambers can have a cartridge that is maintained at a fixed height, while optics are vertically movable. A distance between final optics of a lens assembly and a top surface of powder bed a may be managed to be essentially constant by indexing final optics upwards, by a distance equivalent to a thickness of a powder layer, while keeping the build platform at a fixed height. Advantageously, as compared to a vertically moving the build platform, large and heavy objects can be more easily manufactured, since precise micron scale movements of the ever changing mass of the build platform are not needed. Typically, build chambers intended for metal powders with a volume more than ˜ 0.1-0.2 cubic meters (i.e., greater than 100-200 liters or heavier than 500-1,000 kg) will most benefit from keeping the build platform at a fixed height.

In one embodiment, a portion of the layer of the powder bed in a cartridge may be selectively melted or fused to form one or more temporary walls out of the fused portion of the layer of the powder bed to contain another portion of the layer of the powder bed on the build platform. In selected embodiments, a fluid passageway can be formed in the one or more first walls to enable improved thermal management.

In some embodiments, the additive manufacturing system can include article processing units or cartridges that supports a powder bed capable of tilting, inverting, and shaking to separate the powder bed substantially from the build platform in a hopper. The powdered material forming the powder bed may be collected in a hopper for reuse in later print jobs. The powder collecting process may be automated and vacuuming or gas jet systems also used to aid powder dislodgement and removal.

Some embodiments, the additive manufacturing system can be configured to easily handle parts longer than an available build chamber or cartridge. A continuous (long) part can be sequentially advanced in a longitudinal direction from a first zone to a second zone. In the first zone, selected granules of a granular material can be amalgamated. In the second zone, unamalgamated granules of the granular material can be removed. The first portion of the continuous part can be advanced from the second zone to a third zone, while a last portion of the continuous part is formed within the first zone and the first portion is maintained in the same position in the lateral and transverse directions that the first portion occupied within the first zone and the second zone. In effect, additive manufacture and clean-up (e.g., separation and/or reclamation of unused or unamalgamated granular material) may be performed in parallel (i.e., at the same time) at different locations or zones on a part conveyor, with no need to stop for removal of granular material and/or parts.

In another embodiment, additive manufacturing capability can be improved by use of an enclosure restricting an exchange of gaseous matter between an interior of the enclosure and an exterior of the enclosure. An airlock provides an interface between the interior and the exterior; with the interior having multiple additive manufacturing chambers, including those supporting power bed fusion. A gas management system maintains gaseous oxygen within the interior at or below a limiting oxygen concentration, increasing flexibility in types of powder and processing that can be used in the system.

In another manufacturing embodiment, capability can be improved by having a article processing units, cartridges, or build chamber contained within an enclosure, the build chamber being able to create a part having a weight greater than or equal to 2,000 kilograms. A gas management system may maintain gaseous oxygen within the enclosure at concentrations below the atmospheric level. In some embodiments, a wheeled vehicle may transport the part from inside the enclosure, through an airlock, since the airlock operates to buffer between a gaseous environment within the enclosure and a gaseous environment outside the enclosure, and to a location exterior to both the enclosure and the airlock.

Other manufacturing embodiments involve collecting powder samples in real-time from the powder bed. An ingester system is used for in-process collection and characterizations of powder samples. The collection may be performed periodically and the results of characterizations result in adjustments to the powder bed fusion process. The ingester system can optionally be used for one or more of audit, process adjustments or actions such as modifying printer parameters or verifying proper use of licensed powder materials.

Yet another improvement to an additive manufacturing process can be provided by use of a manipulator device such as a crane, lifting gantry, robot arm, or similar that allows for the manipulation of parts that can be difficult or impossible for a human to move is described. The manipulator device can grasp various permanent or temporary additively manufactured manipulation points on a part to enable repositioning or maneuvering of the part.

Control processor 350 can be connected to control any components of additive manufacturing system 300 described herein, including lasers, laser amplifiers, optics, heat control, build chambers, and manipulator devices. The control processor 350 can be connected to variety of sensors, actuators, heating or cooling systems, monitors, and controllers to coordinate operation. A wide range of sensors, including imagers, light intensity monitors, thermal, pressure, or gas sensors can be used to provide information used in control or monitoring. The control processor can be a single central controller, or alternatively, can include one or more independent control systems. The controller processor 350 is provided with an interface to allow input of manufacturing instructions. Use of a wide range of sensors allows various feedback control mechanisms that improve quality, manufacturing throughput, and energy efficiency.

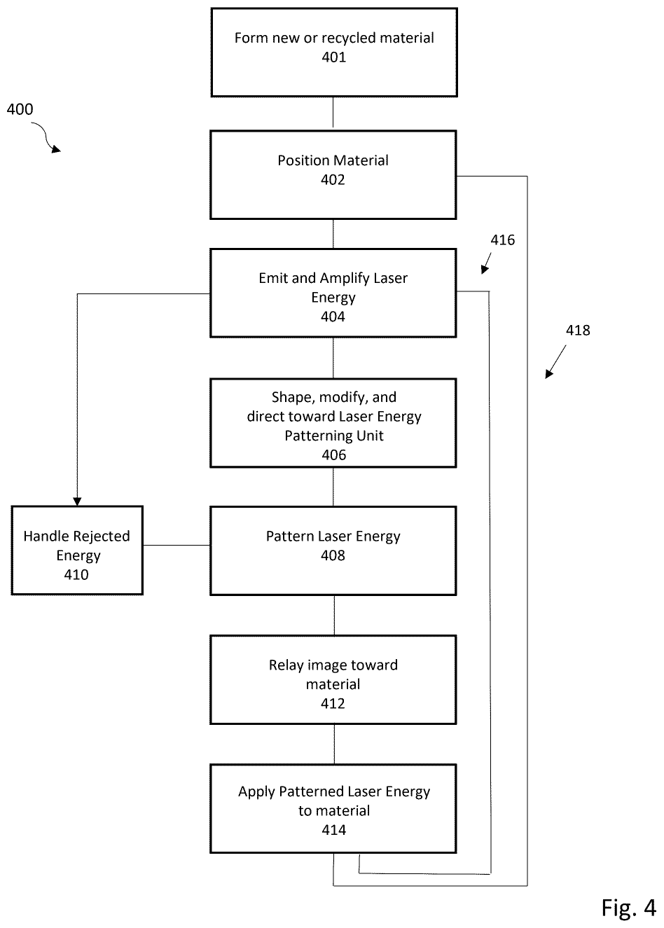

One embodiment of operation of a manufacturing system suitable for additive or subtractive manufacture is illustrated in FIG. 4. In this embodiment, a flow chart 400 illustrates one embodiment of a manufacturing process supported by the described optical and mechanical components. In step 401, material powder created or recycled as discussed in this disclosure is formed. In step 402, the powder material is positioned in a cartridge, bed, chamber, or other suitable support. In some embodiments, the material can be a metal plate for laser cutting using subtractive manufacture techniques, or a powder capable of being melted, fused, sintered, induced to change crystal structure, have stress patterns influenced, or otherwise chemically or physically modified by additive manufacturing techniques to form structures with desired properties.

In step 404, unpatterned laser energy is emitted by one or more energy emitters, including but not limited to solid state or semiconductor lasers, and then amplified by one or more laser amplifiers. In step 406, the unpatterned laser energy is shaped and modified (e.g. intensity modulated or focused). In step 408, this unpatterned laser energy is patterned, with energy not forming a part of the pattern being handled in step 410 (this can include conversion to waste heat, recycling as patterned or unpatterned energy, or waste heat generated by cooling the laser amplifiers in step 404). In step 412, the patterned energy, now forming a one or two-dimensional image is relayed toward the material. In step 414, the image is applied to the material, either subtractively processing or additively building a portion of a 3D structure. For additive manufacturing, these steps can be repeated (loop 418) until the image (or different and subsequent image) has been applied to all necessary regions of a top layer of the material. When application of energy to the top layer of the material is finished, a new layer can be applied (loop 416) to continue building the 3D structure. These process loops are continued until the 3D structure is complete, when remaining excess material can be removed or recycled.

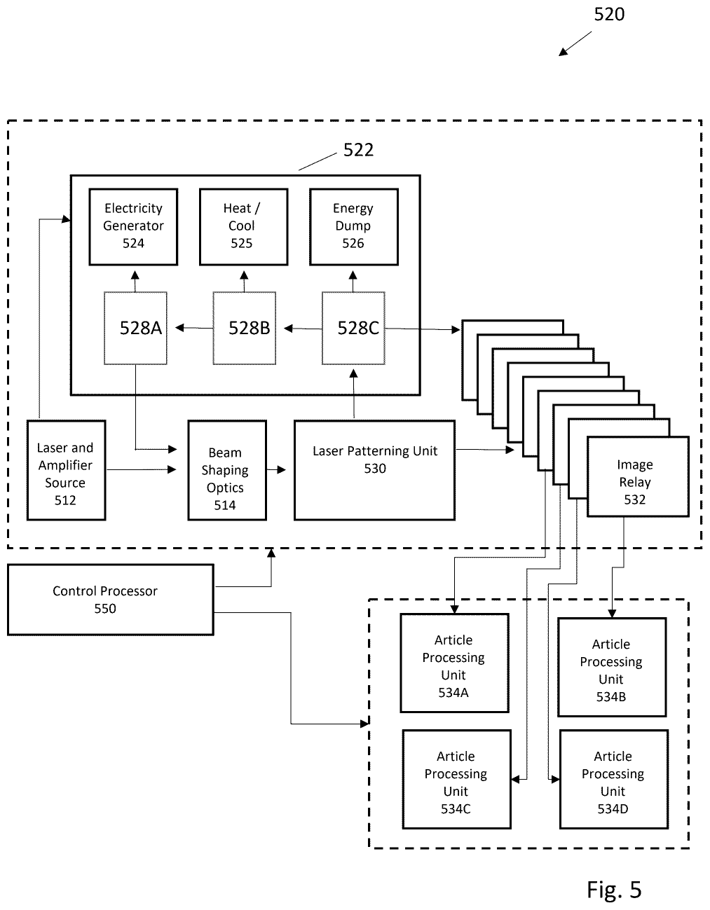

FIG. 5 is one embodiment of an additive manufacturing system that includes a phase change light valve and a switchyard system enabling reuse of patterned two-dimensional energy. An additive manufacturing system 520 has an energy patterning system with a laser and amplifier source 512 that directs one or more continuous or intermittent laser beam(s) toward beam shaping optics 514. Excess heat can be transferred into a rejected energy handling unit 522 that can include an active light valve cooling system. After shaping, the beam is two-dimensionally patterned by an energy patterning unit 530, with generally some energy being directed to the rejected energy handling unit 522. Patterned energy is relayed by one of multiple image relays 532 toward one or more article processing units 534A, 534B, 534C, or 534D, typically as a two-dimensional image focused near a movable or fixed height bed. The bed can be inside a cartridge that includes a powder hopper or similar material dispenser. Patterned laser beams, directed by the image relays 532, can melt, fuse, sinter, amalgamate, change crystal structure, influence stress patterns, or otherwise chemically or physically modify the dispensed material to form structures with desired properties.

In this embodiment, the rejected energy handling unit has multiple components to permit reuse of rejected patterned energy. Coolant fluid from the laser amplifier and source 512 can be directed into one or more of an electricity generator 524, a heat/cool thermal management system 525, or an energy dump 526. Additionally, relays 528A, 528B, and 528C can respectively transfer energy to the electricity generator 524, the heat/cool thermal management system 525, or the energy dump 526. Optionally, relay 528C can direct patterned energy into the image relay 532 for further processing. In other embodiments, patterned energy can be directed by relay 528C, to relay 528B and 528A for insertion into the laser beam(s) provided by laser and amplifier source 512. Reuse of patterned images is also possible using image relay 532. Images can be redirected, inverted, mirrored, sub-patterned, or otherwise transformed for distribution to one or more article processing units 534A-D. Advantageously, reuse of the patterned light can improve energy efficiency of the additive manufacturing process, and in some cases improve energy intensity directed at a bed or reduce manufacture time.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims. It is also understood that other embodiments of this invention may be practiced in the absence of an element/step not specifically disclosed herein.

1. A print engine of an additive manufacturing system, comprising:
a print station with a print bed, powder spreader, and a first and a second powder holding chamber;
first and second powder nozzles respectively connected to the first and a second powder holding chambers;
at least one vibratory element attached to at least one of the print bed, the powder spreader, the first and a second powder holding chambers, and the first and second powder nozzles.

2. The print engine of the additive manufacturing system of claim 1, wherein the vibratory element comprises an ultrasonic agitated blade.

3. The print engine of the additive manufacturing system of claim 1, wherein the vibratory element comprises a vibrational head.

4. The print engine of the additive manufacturing system of claim 1, further comprising a laser able to direct a two dimensional laser image against the print bed.

5. The print engine of the additive manufacturing system of claim 1, wherein size of powder held in the respective first and a second powder holding chambers is different.

6. A print engine of an additive manufacturing system, comprising a print station with a print bed, powder roller, and a first and a second powder holding chamber;
first and second powder nozzles respectively connected to the first and a second powder holding chambers;
at least one vibratory element attached to at least one of the print bed, the powder spreader, the first and a second powder holding chambers, and the first and second powder nozzles.

7. The print engine of the additive manufacturing system of claim 6, wherein the powder roller includes a structured or patterned surface.

8. The print engine of the additive manufacturing system of claim 6, further comprising a laser able to direct a two dimensional laser image against the print bed.

9. The print engine of the additive manufacturing system of claim 6, wherein size of powder held in the respective first and a second powder holding chambers is different.

10. A print engine of an additive manufacturing system, comprising
a print station with a print bed, powder spreader with ultrasonic agitation, and a first and a second powder holding chamber; and
first and second powder nozzles respectively connected to the first and a second powder holding chambers.

11. The print engine of the additive manufacturing system of claim 10, further comprising a laser able to direct a two dimensional laser image against the print bed.

12. The print engine of the additive manufacturing system of claim 10, wherein size of powder held in the respective first and a second powder holding chambers is different.

13. A method of operating a print engine of an additive manufacturing system, comprising:
providing a print station with a print bed, at least one of a powder spreader and a powder roller, and a first and a second powder holding chamber, with first and second powder nozzles respectively connected to the first and a second powder holding chambers;
activating at least one vibratory element attached to at least one of the print bed, the powder spreader, the first and a second powder holding chambers, and the first and second powder nozzles.

14. The method of operating a print engine of an additive manufacturing system of claim 13, wherein the powder roller includes a structured or patterned surface.

15. The method of operating a print engine of an additive manufacturing system of claim 13, further comprising directing a two dimensional laser image against the print bed.

16. The method of operating a print engine of an additive manufacturing system of claim 13, wherein size of powder held in the respective first and a second powder holding chambers is different.

17. The method of operating a print engine of an additive manufacturing system of claim 13, wherein the vibratory element comprises an ultrasonic agitated blade.

18. The method of operating a print engine of an additive manufacturing system of claim 13, wherein the vibratory element comprises a vibrational head.
